(19) United States
(12) Patent Application Publication
(10) Pub. No.: US 2024/0208777 A1
(43) Pub. Date: Jun. 27, 2024

(54) CRANE OPERATION SUPPORT DEVICE AND CRANE

(71) Applicant: SUMITOMO HEAVY INDUSTRIES, LTD., Tokyo (JP)

(72) Inventors: Yasuhiro YAMAMOTO, Kanagawa (JP); Chunnan WU, Kanagawa (JP); Keita NAKAMORI, Kanagawa (JP); Takatoshi ITO, Kanagawa (JP)

(21) Appl. No.: 18/394,935

(22) Filed: Dec. 22, 2023

(30) Foreign Application Priority Data
Dec. 26, 2022 (JP) 2022-208129

(51) Int. Cl. B66C 13/50; B66C 13/44; B66C 23/88

(52) U.S. Cl. CPC B66C 13/50; B66C 13/44; B66C 23/88; B66C 2700/0371

(57) ABSTRACT

A crane operation support device that supports a driving operation of a crane that includes a boom, configured to be capable of switching a driving operation mode between a first operation mode in which each operation of lifting and lowering of a hook suspended from a tip of the boom and turning and derricking of the boom is independently operated, and a second operation mode in which a movement of the hook is operated by a combined operation of the turning of the boom and at least one of the lifting and lowering and the derricking of the hook by a single operation.

### CROSS-REFERENCE TO RELATED APPLICATIONS

This application claims priority to Japanese Patent Application No. 2022-208129, filed on Dec. 26, 2022, which is incorporated by reference herein in its entirety.

### BACKGROUND

### Technical Field

A certain embodiment of the present invention relates to a crane operation support device and a crane.

### Description of Related Art

In general, a main driving operation of a crane is performed by directly controlling movable part parameters such as a boom derricking angle, a boom turning angle, and a suspended load wire length.

Meanwhile, in the technique described in the related art, based on a moving direction of a suspended load (hook) input by operation means, the movable part parameters are controlled such that the suspended load moves linearly in the moving direction. In this way, an intuitive crane operation is realized.

### SUMMARY

According to an embodiment of the present invention, there is provided a crane operation support device that supports a driving operation of a crane that includes a boom, configured to be capable of switching a driving operation mode between a first operation mode in which each operation of lifting and lowering of a hook suspended from a tip of the boom and turning and derricking of the boom is independently operated, and a second operation mode in which a movement of the hook is operated by a combined operation of the turning of the boom and at least one of the lifting and lowering and the derricking of the hook by a single operation.

According to another embodiment of the present invention, there is provided a crane including the crane operation support device.

### BRIEF DESCRIPTION OF THE DRAWINGS

FIG. 1 is a side view showing a crane according to an embodiment.

FIG. 2 is a block diagram showing a schematic functional configuration of the crane according to the embodiment.

FIG. 3 is a diagram showing a disposition example of a driving operation part and a display operation part within a cabin.

FIG. 4 is a flowchart showing a flow of operation support processing according to the embodiment.

### DETAILED DESCRIPTION

However, in the technique described in the related art, since control in which a plurality of movable part parameters having different drive speeds are combined is performed, there is a concern that work speed may be reduced.

The present invention has been made in view of the above circumstances, and it is desirable to realize an intuitive crane operation while suppressing a decrease in work speed.

Hereinafter, each embodiment of the present invention will be described in detail with reference to the drawings.

### Configuration of Crane

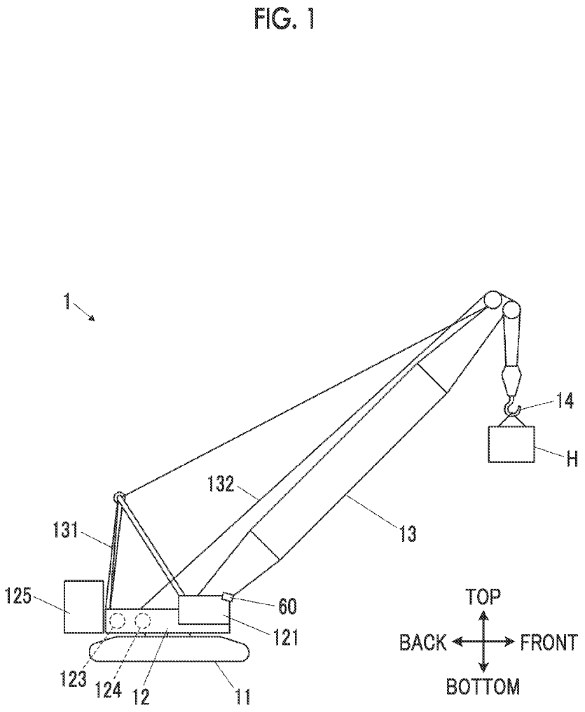

FIG. 1 is a side view showing a crane 1 according to an embodiment.

As shown in this drawing, the crane 1 is a so-called mobile crawler crane. Specifically, the crane 1 includes a self-propelled crawler-type lower traveling body 11, and a rotating platform 12 turnably mounted on the lower traveling body 11.

In the following, each direction of front-back, right-left, and up-down directions as seen from an occupant (an operator) of the crane 1 will be described as the relevant direction of the crane 1. That is, description will be made with a direction from a turning axis of the crane 1 toward a position where a counterweight 125 is disposed being a back side and the opposite side being a front side (a direction where a boom 13 is disposed).

The boom 13 is mounted on a front portion of the rotating platform 12 so as to be able to perform derricking. A cabin 121 in which an operator sits and operates the crane 1 is disposed at a front right portion of the rotating platform 12.

A derricking operation of the boom 13 is performed by winding or unwinding a wire rope (a derricking rope) 131 via a derricking winch 123.

A hook 14 is suspended from a tip (upper end) of the boom 13 through a hoisting rope 132. In the hoisting rope 132, a side opposite to a tip end side connected to the hook 14 is wound around a lifting and lowering winch 124 on the rotating platform 12. A lifting and lowering operation of the hook 14 is performed by winding or unwinding the hoisting rope 132 via the lifting and lowering winch 124.

With the above configuration, the crane 1 can move a suspended load H to a position above a transport destination by hanging the suspended load H on the hook 14, winding up the hoisting rope 132 to lift the suspended load H, and then turning the rotating platform 12, and changing a derricking angle of the boom 13 if necessary. Thereafter, the crane 1 can lower the suspended load H to the transport destination by unwinding the hoisting rope 132.

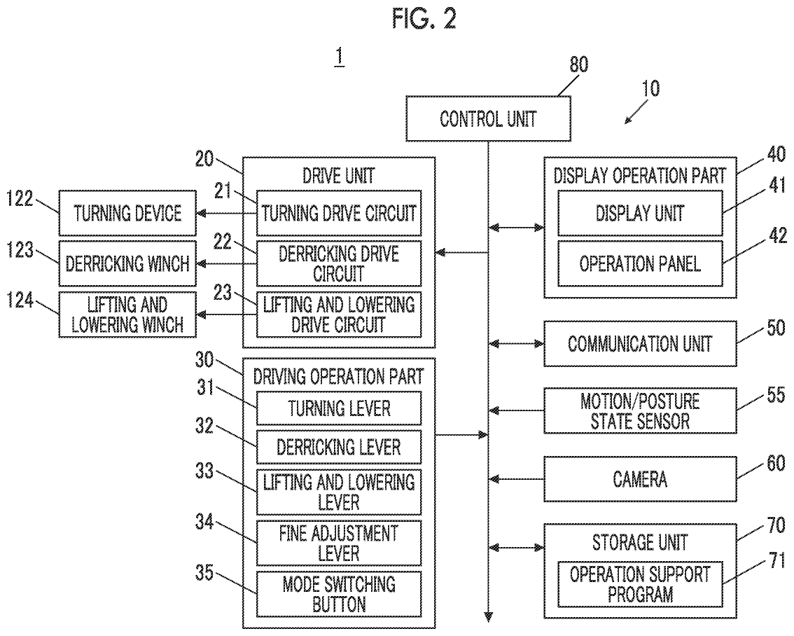

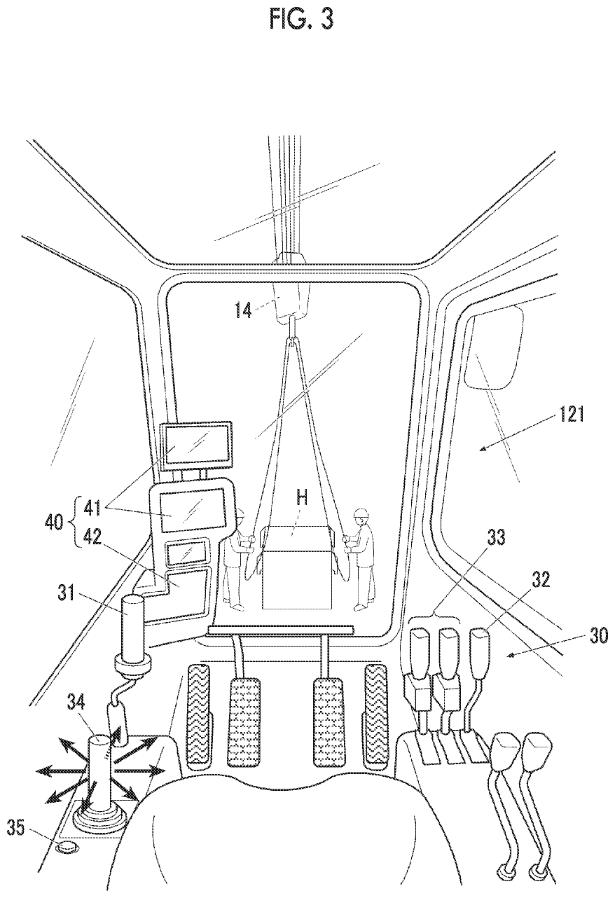

FIG. 2 is a block diagram showing a schematic functional configuration of the crane 1, and FIG. 3 is a diagram showing a disposition example of a driving operation part 30 (described later) and a display operation part 40 (described later) within the cabin 121, and is a view from the viewpoint of an operator seated in the cabin 121 and looking forward.

As shown in FIG. 2, the crane 1 includes, in addition to the above configuration, a drive unit 20, the driving operation part 30, the display operation part 40, a communication unit 50, a motion/posture state sensor 55, a camera 60, a storage unit 70, and a control unit. 80. Of these, the driving operation part 30 and the display operation part 40 may be disposed within the cabin 121, for example. Further, the crane 1 includes a crane operation support device 10. The crane operation support device 10 includes the driving operation part 30, the camera 60, and the control unit 80.

The drive unit 20 is a drive circuit that operates each part of the crane 1, and includes a turning drive circuit 21, a derricking drive circuit 22, and a lifting and lowering drive circuit 23.

The turning drive circuit 21 drives a turning device 122 of the rotating platform 12. The turning device 122 receives power from a hydraulic motor that rotates with pressure oil that is supplied from a hydraulic pump, for example, and turns the rotating platform 12. The turning drive circuit 21 drives or brakes the turning device 122 by operating the hydraulic motor by driving a control valve disposed between the hydraulic pump and the hydraulic motor, based on a turning request signal that is output from the control unit 80.

The derricking drive circuit 22 drives the derricking winch 123. The derricking winch 123 rotates a drum by receiving power from a hydraulic motor that rotates with pressure oil that is supplied from a hydraulic pump, and performs the derricking of the boom 13 by winding the wire rope (derricking rope) 131 around a drum or unwinding the wire rope 131 from the drum. The derricking drive circuit 22 drives the derricking winch 123 by operating the hydraulic motor by driving a control valve disposed between the hydraulic pump and the hydraulic motor, based on a derricking request signal that is output from the control unit 80.

The lifting and lowering drive circuit 23 drives the lifting and lowering winch 124. The lifting and lowering winch 124 rotates a drum by receiving power from a hydraulic motor that rotates with pressure oil that is supplied from a hydraulic pump, and performs the lifting and lowering of the hook 14 by winding the hoisting rope 132 around a drum or unwinding the hoisting rope 132 from the drum. The lifting and lowering drive circuit 23 drives the lifting and lowering winch 124 by operating the hydraulic motor by driving a control valve disposed between the hydraulic pump and the hydraulic motor, based on a lifting and lowering request signal that is output from the control unit 80.

As shown in FIG. 3, the driving operation part 30 is operation means for accepting a driving operation of the crane 1 by the operator.

The driving operation part 30 includes a turning lever 31 for performing a turning operation, a derricking lever 32 for performing a derricking operation, and a lifting and lowering lever 33 for performing a lifting and lowering operation. The turning lever 31, the derricking lever 32, and the lifting and lowering lever 33 are examples of a first operation part according to the present invention, and are operation means for accepting operation input in a normal mode (described later). The driving operation part 30 outputs an operation signal corresponding to the operation content of each of these levers to the control unit 80. The control unit 80 determines the type of operation, based on the input operation signal, and when the operation is a turning operation, the control unit 80 outputs a turning command corresponding to the operation to the turning drive circuit 21, when the operation is a derricking operation, the control unit 80 outputs a derricking command corresponding to the operation to the derricking drive circuit 22, and when the operation is a lifting and lowering operation, the control unit 80 outputs a lifting and lowering command corresponding to the operation to the lifting and lowering drive circuit 23.

Further, the driving operation part 30 includes a fine adjustment lever 34 for finely adjusting the position of the hook 14, and a mode switching button 35 for switching a driving operation mode.

The fine adjustment lever 34 is an example of a second operation part according to the present invention, and is operation means for finely adjusting the position of the hook 14 within a horizontal plane in a fine adjustment mode (described later). The fine adjustment lever 34 can be operated in four directions, that is, the front-back and right-left directions of the crane 1, and any direction diagonal to the four directions. Further, the fine adjustment lever 34 is a joystick that stands up substantially up and down and that has a neutral position at its center position, and a tilting direction (operation direction) thereof corresponds to a moving direction of the hook 14.

When the fine adjustment lever 34 is operated in the fine adjustment mode, the driving operation part 30 outputs an operation signal corresponding to the operation direction of the fine adjustment lever 34 to the control unit 80. The control unit 80 determines the operation direction of the fine adjustment lever 34, based on an input operation signal, and operates at least one of the turning drive circuit 21, the derricking drive circuit 22, and the lifting and lowering drive circuit 23 according to the operation direction. More specifically, the control unit 80 executes at least one of the turning and the derricking of the boom 13 and the lifting and lowering of the hook 14 such that the position (projected position) of the hook 14 on the horizontal plane moves corresponding to the operation direction of the fine adjustment lever 34. For example, in a case where the fine adjustment lever 34 is tilted forward, the control unit 80 operates the derricking drive circuit 22 to perform lowering of the hook 14 and linearly moves the position of the hook 14 on the horizontal plane forward. Further, in a case where the fine adjustment lever 34 is tilted to the right, the control unit 80 operates the turning drive circuit 21 and the derricking drive circuit 22 to perform lowering of the hook 14 while turning it to the right, and linearly moves the position of the hook 14 on the horizontal plane to the right.

The fine adjustment lever 34 (that is, an operation in a fine adjustment mode) may operate the movement of the hook 14 along any one of two orthogonal axes in a plane intersecting a vertical direction (the direction of gravity) via a combined operation of the turning of the boom 13 and at least one of the lifting and lowering and the derricking of the hook 14. In other words, the fine adjustment mode may be a mode in which a combined operation of the turning of the boom 13 and at least one of the lifting and lowering and the derricking of the hook 14 is operated by a single operation of the fine adjustment lever 34. That is, the movement of the hook 14 by the fine adjustment lever 34 may include not only a movement within the horizontal plane but also lifting and lowering. Further, the directions of the two orthogonal axes (in the present embodiment, the front-back direction and right-left direction of the crane 1) are not particularly limited.

The mode switching button 35 is a switching operation part that switches the driving operation mode between the normal mode (a first operation mode) and the fine adjustment mode (a second operation mode). In an OFF state (an ordinary state) where the mode switching button 35 is not pressed, the driving operation mode is in the normal mode, the turning lever 31, the derricking lever 32, and the lifting and lowering lever 33 function, and the fine adjustment lever 34 does not function. When the mode switching button 35 in the OFF state is pressed to be in an ON state, the driving operation mode is switched from the normal mode to the fine adjustment mode, the fine adjustment lever 34 functions, and the turning lever 31, the derricking lever 32, and the lifting and lowering lever 33 do not function. When the mode switching button 35 in the ON state is pressed, it returns to the OFF state.

The fine adjustment mode is a driving operation mode more suitable for a fine movement of the hook 14 than in the normal mode, and at least one of a movement speed and an amount of movement of the hook 14 becomes smaller than in the normal mode. That is, the fine adjustment mode is a driving operation mode in which an operation is restricted compared to the normal mode.

Specifically, in the fine adjustment mode, for example, the movement speed of the hook 14 is set to a lower maximum value (upper limit value) than in the normal mode. This maximum value may be the minimum value within a controllable numerical range, and may be set by the operator. Such a restriction of the movement speed of the hook 14 can be realized, for example, by setting a flow rate restriction of the amount of oil that is supplied to the hydraulic motor of a corresponding drive circuit. More specifically, the restriction can be realized, for example, by restricting at least one of a maximum rotational speed of the lifting and lowering winch 124 (that is, the maximum winding or unwinding speed of the hoisting rope 132) and a maximum turning angular speed of the boom 13. In particular, in each operation, normally, a speed at which the hook moves is different depending on the amount of operation. For example, a derricking speed is slower than a turning speed. In this case, for example, the maximum turning angular speed may be reduced to improve operability in the second operation mode.

Further, in the fine adjustment mode, an upper limit of the amount of movement of the hook 14 may be set with respect to one operation input (tilting) of the fine adjustment lever 34 (the hook 14 stops after moving to the upper limit of the amount of movement).

Further, in the fine adjustment mode, the movement speed of the hook 14 may be constant regardless of the input amount (tilting angle) of the fine adjustment lever 34, and the movement speed of the hook 14 may become faster gradually as the fine adjustment lever 34 continues to be tilted.

The display operation part 40 includes a display unit 41 that displays various information by outputting images, sound, or the like, and an operation panel 42 that can be operated by the operator to input information or the like. The display unit 41 displays various information, based on display signals that are input from the control unit 80. The operation panel 42 outputs an operation signal to the control unit 80 according to the content of the operator's operation. The display unit 41 may be a touch panel that also serves as at least a part of the operation panel 42.

As shown in FIG. 2, the communication unit 50 is a communication device that can directly (or indirectly through a communication network or the like) transmit and receive various information to and from, for example, an information terminal (not shown).

The camera 60 is mounted on an upper part of the cabin 121 to face forward, and captures a predetermined range in front of the crane 1. Image information obtained by the capturing is recorded in the storage unit 70.

The motion/posture state sensor 55 is a sensor that detects a motion state or a posture state of the crane 1, and outputs the detection result to the control unit 80. The motion/posture state sensor 55 includes, for example, a boom angle sensor, a three-axis inertia sensor (inertial measurement unit: IMU), a turning angle sensor, and an acceleration sensor. The boom angle sensor detects the derricking angle of the boom 13. The IMU is mounted on the boom 13 and detects an acceleration and an angular acceleration of the boom 13 regarding predetermined three axes. The turning angle sensor detects the turning angle of the rotating platform 12 with respect to a predetermined angular direction. The acceleration sensor detects an acceleration of the rotating platform 12.

Further, the motion/posture state sensor 55 can detect the vertical direction via the acceleration sensor. The motion/posture state sensor 55 is not limited to the above configuration, and other sensors may be used. For example, a global navigation satellite system (GNSS) may be provided, and the derricking angle or the like of the boom 13 may be calculated based on the position information thereof.

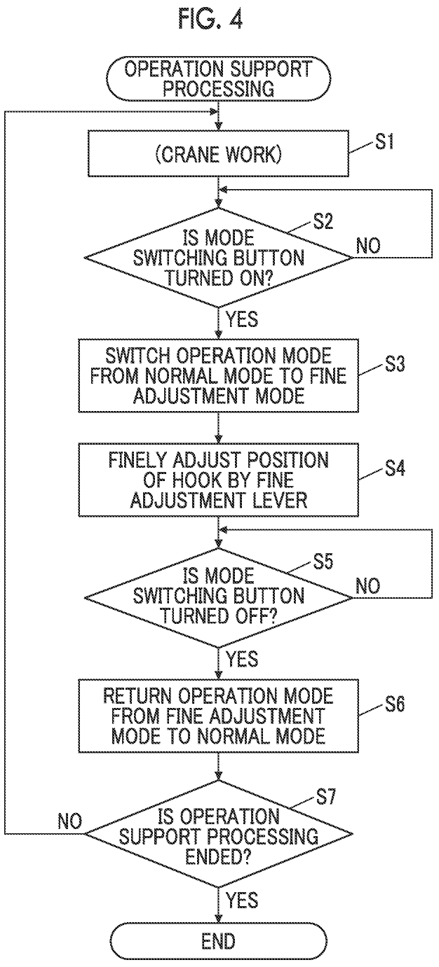

The storage unit 70 is a memory configured with, for example, a random-access memory (RAM), a read-only memory (ROM), or the like, and stores various programs and data, and also functions as a work area for the control unit 80. The storage unit 70 in the present embodiment stores in advance an operation support program 71 for executing operation support processing (refer to FIG. 4), which will be described later.

The control unit 80 is configured with, for example, a central processing unit (CPU) and the like, and controls the operation of each part of the crane 1 in an integrated manner. The control unit 80 includes the function of an electronic control unit (ECU), and is disposed in the rotating platform 12. Specifically, the control unit 80 operates the drive unit 20, based on the operator's operation input or the like, deploys a program stored in advance in the storage unit 70, and executes various processing in cooperation with the deployed program.

### Operation Support Processing

Subsequently, the operation support processing that supports the operator's driving operations will be described. FIG. 4 is a flowchart showing a flow of the operation support processing.

The operation support processing is processing that supports the operator's operations during crane work, and in the present embodiment, the movement of the hook 14 can be intuitively operated during slinging work. The slinging work is work in which a slinging worker hangs the suspended load H on the hook 14 (or removes the suspended load H from the hook 14) directly or with a wire rope or the like. The operation support processing is executed, for example, by causing the control unit 80 to read out and deploy the operation support program 71 according to an execution operation by the operator.

As shown in FIG. 4, when the operation support processing is executed, first, the control unit 80 operates the crane 1, based on the operator's operation, to perform crane work (step S1).

At this time, the mode switching button 35 is in the OFF state, and the driving operation mode is in the normal mode. In the normal mode, the operator operates the crane 1 by operating the turning lever 31, the derricking lever 32, and the lifting and lowering lever 33 to independently operate each operation of the turning and derricking of the boom 13 and the lifting and lowering of the hook 14. The expression “independent operation” includes turning according to an angle in the right-left direction, and independent derricking and lowering according to an angle in the front-back direction by the movement of a lever (joystick) in any direction. In this case, since turning and derricking are performed only with the angle of each lever, for example, in a case where the lever is tilted in the right-left direction at 90 degrees with respect to the front-back direction, only the turning is performed and the derricking is not performed. Such an operation is not for moving the hook by combining two operations of the turning and the derricking via a single operation, and is for moving the hook by independently operating each of the turning and the derricking via two operation parts.

Next, the control unit 80 determines whether or not the mode switching button 35 is in the ON state, that is, whether or not the mode switching button 35 has been pressed by an operator's operation (step S2). Then, in a case where it is determined that the mode switching button 35 remains in the OFF state (step S2; No), the control unit 80 repeats the processing of step S2.

On the other hand, in a case where in step S2, it is determined that the mode switching button 35 is in the ON state (step S2; Yes), the control unit 80 switches the driving operation mode from the normal mode to the fine adjustment mode (step S3).

By switching the mode to the fine adjustment mode, the fine adjustment lever 34 becomes usable (is in a functioning state), and the turning lever 31, the derricking lever 32, and the lifting and lowering lever 33 become unusable (are in a non-functioning state).

Next, the control unit 80 finely adjusts the position of the hook 14, based on the operator's operation input of the fine adjustment lever 34 (step S4).

In the present embodiment, fine adjustment of the position of the hook 14 during slinging work is performed by the fine adjustment lever 34. At this time, by the operation of the fine adjustment lever 34, the hook 14 is moved linearly along the front-back direction, the right-left direction, or a diagonal direction of the crane 1, so that the operator can intuitively operate the hook 14. Further, since the hook 14 moves in the direction corresponding to the tilting direction of the fine adjustment lever 34 (for example, when the fine adjustment lever 34 is tilted forward, the hook 14 also moves forward), the operator can more intuitively operate the hook 14.

Further, at this time, since at least one of the movement speed and the amount of movement of the hook 14 is smaller than that in the normal mode, the operator can suitably finely adjust the position of the hook 14.

Next, the control unit 80 determines whether or not the mode switching button 35 is in the OFF state, that is, whether or not the mode switching button 35 has been pressed by an operator's operation (step S5). Then, in a case where it is determined that the mode switching button 35 remains in the ON state (step S5; No), the control unit 80 repeats the processing of step S5.

On the other hand, in a case where in step S5, it is determined that the mode switching button 35 is in the OFF state (step S5; Yes), the control unit 80 returns the driving operation mode from the fine adjustment mode to the normal mode (step S6).

In this way, the turning lever 31, the derricking lever 32, and the lifting and lowering lever 33 become usable, and the fine adjustment lever 34 becomes unusable.

Next, the control unit 80 determines whether or not to end the operation support processing (step S7), and in a case where it is determined not to end the operation support processing (step S7; No), the processing is shifted to step S1 described above, and the crane work is continued.

Then, for example, in a case where it is determined that the operation support processing is to be ended due to completion of the movement of the suspended load H to a predetermined position (step S7; Yes), the control unit 80 ends the operation support processing.

### Technical Effect of the Present Embodiment

As described above, according to the present embodiment, a configuration is made such that the driving operation mode can be switched between the normal mode (the first operation mode) in which the lifting and lowering of the hook 14 and at least one of the turning and the derricking of the boom 13 are operated, and the fine adjustment mode (the second operation mode) in which the movement of the hook 14 is operated by a combined operation of the turning of the boom 13 and at least one of the lifting and lowering and the derricking of the hook 14 by a single operation.

In this way, for example, while performing an operation in the normal mode during work other than slinging, it is possible to change the mode to the fine adjustment mode as necessary during slinging work or the like and to intuitively operate the position of the hook 14 along two orthogonal axes.

Therefore, in the fine adjustment mode, since the controls of parameters of a plurality of movable parts having different drive speeds are combined, the work speed may decrease, and thus, unlike the related art in which such an operation is performed constantly, it is possible to realize intuitive crane operation while suppressing a decrease in work speed.

Further, according to the present embodiment, the fine adjustment mode is a driving operation mode in which operations are restricted compared to the normal mode.

In this way, for example, by making at least one of the movement speed and the amount of movement of the hook 14 small, it is possible to suitably finely adjust the position of the hook 14.

Further, according to the present embodiment, the fine adjustment lever 34 that accepts operation input in the fine adjustment mode is different from the operation parts (the turning lever 31, the derricking lever 32, and the lifting and lowering lever 33) that accept operation input in the normal mode.

In this way, the crane 1 can be operated by clearly distinguishing between the two driving operation modes without confusing the two driving operation modes and making a mistake in operation.

Further, according to the present embodiment, the fine adjustment lever 34 is configured to allow input in diagonal directions with respect to the front-back direction and the right-left direction.

In this way, unlike in the normal mode, it is possible to more intuitively and easily perform the position adjustment in the diagonal direction of the hook 14.

Further, according to the present embodiment, the mode switching button 35 is provided which accepts a switching operation that switches the driving operation mode between the normal mode and the fine adjustment mode.

Therefore, transition to the fine adjustment mode or return to the normal mode can be easily performed merely by operating the mode switching button 35.

### Other

The embodiment of the present invention has been described above. However, the present invention is not limited to the embodiment described above.

For example, in the embodiment described above, in the fine adjustment mode, the turning lever 31, the derricking lever 32, and the lifting and lowering lever 33 which are used in the normal mode are all disabled. However, in the fine adjustment mode, the lifting and lowering lever 33 among the levers may be usable. That is, in the fine adjustment mode, the movement of the hook 14 may be capable of being operated independently of the movement of the hook 14 along the two orthogonal axes (front-back and right-left) and without affecting the movement (that is, along the direction perpendicular to the plane including the two orthogonal axes). In this case, the work of lifting and suspending the suspended load H can be performed as is.

Further, in the embodiment described above, the fine adjustment lever 34 is set to be a joystick. However, the specific configuration of the operation part (direction input means) that is used in the fine adjustment mode is not limited to a joystick shape, and may be, for example, a cross button shape, a touch panel, or the like. Further, the fine adjustment lever 34 may be capable of inputting operations in eight directions, that is, the four directions of the front-back and right-left of the crane 1 and the four directions diagonally at 45 degrees to the front-back and right-left directions.

Further, the operation part that is used in the fine adjustment mode may be configured as a portable controller independent from the crane 1 and capable of performing short-range wireless communication with the crane 1, and to be capable of being operated by a slinging worker. However, in this case, it is preferable that the switching operation part for switching the driving operation mode remains disposed on the crane 1. Further, at least a part of the crane operation support device including the operation part may be provided outside the cabin 121 (including remote control).

Further, the operation part that is used in the fine adjustment mode does not need to be different from the operation part that is used in the normal mode. In the case of the embodiment described above, the position of the hook 14 may be operated by the turning lever 31, the derricking lever 32, and the lifting and lowering lever 33 even in the fine adjustment mode. That is, in the fine adjustment mode, in addition to the operation by the operation of the fine adjustment lever 34, an operation according to the operation of at least one of the turning lever 31, the derricking lever 32, and the lifting and lowering lever 33 may be capable of being added. However, in this case, when switching the mode to the fine adjustment mode, in at least the turning and derricking operations of the boom 13, at least one of its movement speed and the amount of movement become smaller than in the normal mode. Specifically, in a case where a load is the same, the movement speed becomes lower relative to the amount of operation input.

Further, in the embodiment described above, the driving operation mode is switched between the normal mode and the fine adjustment mode by the operation of the mode switching button 35 by the operator. However, switching from the normal mode to the fine adjustment mode may be performed in a case where a situation in which fine adjustment of the position of the hook 14 is required is detected.

Specifically, in an ordinary state where fine adjustment of the position of the hook 14 is not required, the control unit 80 selects the normal mode, and in a case where in the normal mode, a slinging worker is detected by the camera 60 around the crane 1 (for example, within a predetermined range), the control unit 80 may perform switching from the normal mode to the fine adjustment mode. At this time, in a case where the camera 60 detects a slinging worker who is present directly below the hook 14 (that is, detects that slinging work or unslinging work is performed on the hook 14), the control unit 80 may cause, for example, the display unit 41 to display a message such as “Do you want to switch to the fine adjustment mode?”, and prompt the operator to switch from the normal mode to the fine adjustment mode (select whether or not to switch). Then, in a case where the operator inputs a driving operation mode switching operation, this switching may be performed. In this way, since it becomes easier to switch the driving operation mode at the timing of slinging or unslinging, labor required for switching is reduced and the operation becomes easier.

The condition for switching from the normal mode to the fine adjustment mode is not limited to the detection of the slinging worker by a camera (image processing), and, for example, in a case where the relative distance between the slinging worker and the hook 14 approaches within a predetermined range, switching from the normal mode to the fine adjustment mode may be performed (or be prompted). The slinging worker may be detected by, for example, a beacon or the like. Further, an unloading position (target position) may be simply determined, and the switching may be performed in a case where the hook 14 moves around the unloading position. Further, the return from the fine adjustment mode to the normal mode may be performed, for example, even in a case where the relative distance between the slinging worker and the hook 14 is outside a predetermined range, or even in a case where a switching operation is input by the operator.

Further, in the embodiment described above, the position of the hook 14 is operated by the turning and derricking of the boom 13 and the lifting and lowering of the hook 14. However, extending and contracting of the boom 13 may be included. That is, in a case where the fine adjustment lever 34 is operated in the fine adjustment mode, at least one of the turning, the derricking, and the extending and contracting of the boom 13 and the lifting and lowering of the hook 14 may be executed.

Further, the use of the fine adjustment mode is not limited to slinging work if it is a situation in which fine adjustment of the position of the hook 14 is required.

Further, the crane according to the present invention broadly includes cranes having a turnable boom with a hook suspended from a tip thereof, and may be any crane such as a wheel crane, a truck crane, a jib crane, a tower crane, or the like, for example. Further, the crane according to the present invention includes an excavator having a hook suspended from a bucket.

In addition, the details shown in the embodiment can be appropriately changed within a scope which does not depart from the concept of the invention.

It should be understood that the invention is not limited to the above-described embodiment, but may be modified into various forms on the basis of the spirit of the invention. Additionally, the modifications are included in the scope of the invention.

What is claimed is:

1. A crane operation support device that supports a driving operation of a crane that includes a boom, configured to be capable of switching a driving operation mode between
a first operation mode in which each operation of lifting and lowering of a hook suspended from a tip of the boom and turning and derricking of the boom is independently operated, and
a second operation mode in which a movement of the hook is operated by a combined operation of the turning of the boom and at least one of the lifting and lowering and the derricking of the hook by a single operation.

2. The crane operation support device according to claim 1,
wherein the second operation mode is a driving operation mode in which operations are restricted compared to the first operation mode.

3. The crane operation support device according to claim 2,
wherein in the second operation mode, at least one of a maximum rotational speed of a winch that winds and unwinds a rope for suspending the hook and a maximum turning angular speed of the boom is restricted.

4. The crane operation support device according to claim 1, comprising:
a first operation part that accepts operation input in the first operation mode; and
a second operation part that accepts operation input in the second operation mode and that is different from the first operation part.

5. The crane operation support device according to claim 1,
wherein the second operation mode is a mode in which a combined operation of the lifting and lowering of the hook and the turning and derricking of the boom is operated by a single operation.

6. The crane operation support device according to claim 1,
wherein in the second operation mode, in addition to an operation by the single operation, a lifting and lowering operation according to an operation of a lifting and lowering operation part different from an operation part that performs the single operation is capable of being added.

7. The crane operation support device according to claim 1, comprising:
a switching operation part that accepts a switching operation for switching the driving operation mode between the first operation mode and the second operation mode.

8. The crane operation support device according to claim 1, comprising:
a detection unit that detects that slinging work or unslinging work is performed on the hook; and
mode selection unit that selects a driving operation mode,
wherein the mode selection unit selects the first operation mode in an ordinary state, and
in a case where the detection unit detects that slinging work or unslinging work is performed on the hook, an operator is prompted to perform switching from the first operation mode to the second operation mode, or the switching is performed.

9. The crane operation support device according to claim 8,
wherein the detection unit detects a worker who is present in a vicinity directly below the hook, and in a case where the detection unit detects the worker who is present in the vicinity directly below the hook, the operator is prompted to perform switching from the first operation mode to the second operation mode, or the switching is performed.

10. A crane comprising:
the crane operation support device according to claim 1.
